(19) United States
(12) Patent Application Publication
(10) Pub. No.: US 2026/0360336 A1
(43) Pub. Date: Nov. 12, 2026

(54) SHOULDER STRAP CONNECTOR FOR GUITARS

(71) Applicant: Christopher Burris, Burlington, WI (US)

(72) Inventor: Christopher Burris, Burlington, WI (US)

(21) Appl. No.: 19/199,587

(22) Filed: May 6, 2025

(51) Int. Cl. G10G 5/00

(52) U.S. Cl. CPC G10G 5/005

(57) ABSTRACT

A connector assembly for mounting a shoulder strap to a guitar or similar instrument includes a knob mount which comprises a cinching cord and a sleeve. The cinching cord forms a loop, and the sleeve is slidable along a pair of segments of the cinching cord to adjust a size of the loop. A strap mount is coupled to the cinching cord of the knob mount and comprises a hitching cord which forms a closed loop. The closed loop of the hitching cord mounts to a shoulder strap by inserting it through a hole in the shoulder strap and being drawn over a free end of the shoulder strap and the knob mount. The knob mount cinches to an attachment knob of an instrument.

### (B) CROSS-REFERENCE TO RELATED APPLICATIONS

Not Applicable

### (C) STATEMENT REGARDING FEDERALLY SPONSORED RESEARCH OR DEVELOPMENT

Not Applicable

### (D) THE NAMES OF THE PARTIES TO A JOINT RESEARCH AGREEMENT

Not Applicable

### (E) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (F) STATEMENT REGARDING PRIOR DISCLOSURES BY THE INVENTOR OR JOINT INVENTOR

Not Applicable

### (G) BACKGROUND OF THE INVENTION

### (1) Field of the Invention

The disclosure relates to connector apparatuses and more particularly pertains to a new connector apparatus for mounting a shoulder strap to a guitar or similar instrument.

### (2) Description of Related Art Including Information Disclosed under 37 CFR 1.97 and 1.98.

Shoulder straps for guitars and similar instruments are often designed to have a receiving hole through which an attachment knob positioned on a guitar may be inserted. The attachment knobs may have a head and a neck such that the shoulder strap flexes to expand the receiving hole to press the shoulder strap past the head, then the receiving hole is returned to an original size such that the shoulder strap may closely surround the neck. To facilitate this process, a slit may be formed in the shoulder strap which is in fluid communication with the receiving hole. However, some attachment knobs may be too large for the neck to seat properly within the receiving hole of the shoulder strap, causing the attachment knob to dislodge from the receiving hole.

An apparatus is needed to adapt such shoulder straps for use with guitars and similar instruments that have attachment knobs that are too large to seat properly within the receiving holes of the shoulder straps. The prior art discloses various connection means for mounting shoulder straps to stringed instruments like guitars. However, the prior art fails to describe such an apparatus which includes a cinching mechanism for attachment to the attachment knob and a closed loop for hitching to the shoulder strap via insertion through the receiving hole and extension around a free end of the shoulder strap and the cinching mechanism.

### (H) BRIEF SUMMARY OF THE INVENTION

An embodiment of the disclosure meets the needs presented above by generally comprising a knob mount which includes a cinching cord and a sleeve. The cinching cord forms a loop between a first end segment and a second end segment of the cinching cord, and the sleeve is slidably mounted around the first and second end segments of the cinching cord. The sleeve is slidable along the cinching cord to adjust a size of the loop of the cinching cord. A strap mount is coupled to the first end segment of the cinching cord of the knob mount and comprises a hitching cord which forms a closed loop. The closed loop of the hitching cord is sized and configured to mount to a shoulder strap by being inserted through a receiving hole of the shoulder strap proximate to a free end of the shoulder strap and receiving the knob mount through the closed loop. The knob mount attaches to an attachment knob of a stringed instrument such as a guitar by receiving the attachment knob into the loop of the cinching cord and constricting the loop around the attachment knob.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (I) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front kit view of a connector assembly according to an embodiment of the disclosure.

FIG. 2 is a rear kit view of an embodiment of the disclosure.

FIG. 3 is an in-use view of an embodiment of the disclosure depicting a first step in attaching the connector assembly to a shoulder strap.

FIG. 4 is an in-use view of an embodiment of the disclosure depicting a second step in attaching the connector assembly to the shoulder strap.

FIG. 5 is an in-use view of an embodiment of the disclosure depicting a third step in attaching the connector assembly to the shoulder strap.

FIG. 6 is an in-use view of an embodiment of the disclosure depicting a fourth step in attaching the connector assembly to the shoulder strap.

FIG. 7 is an in-use view of an embodiment of the disclosure depicting the connector assembly mounted to the shoulder strap and positioned near an attachment knob of a guitar.

FIG. 8 is an in-use view of an embodiment of the disclosure depicting the connector assembly mounted to the shoulder strap and the attachment knob of the guitar.

FIG. 9 is a detail in-use view of an embodiment of the disclosure depicting the connector assembly mounted to the shoulder strap and the attachment knob of the guitar.

FIG. 10 is an in-use view of an embodiment of the disclosure depicting the connector assembly mounted to another shoulder strap.

### (J) DETAILED DESCRIPTION OF THE INVENTION

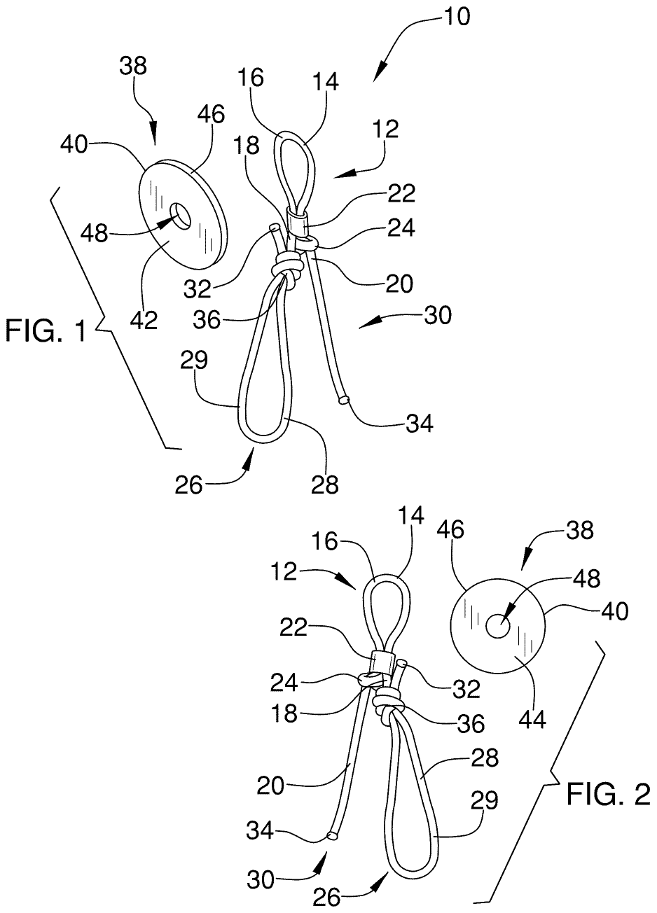

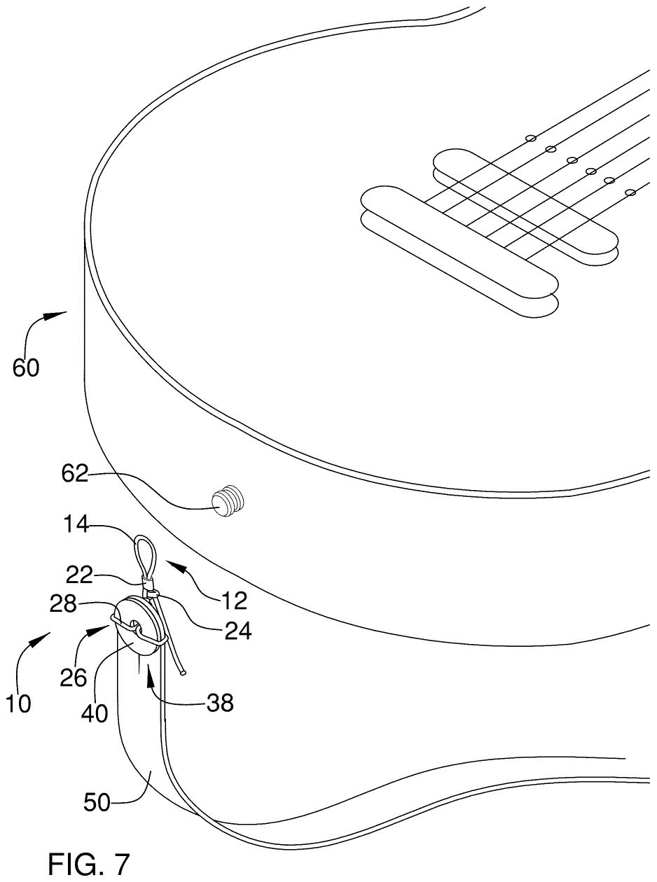

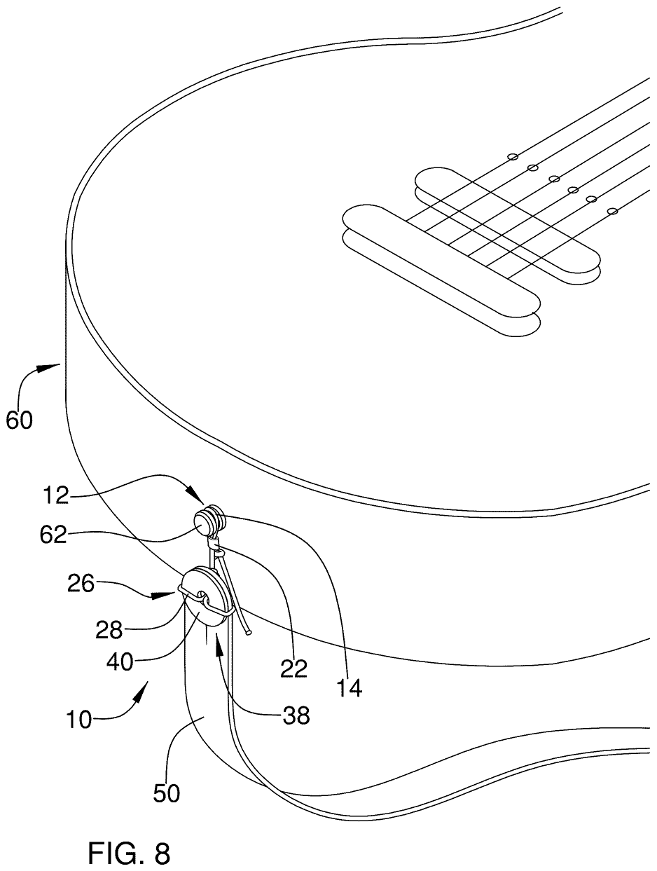

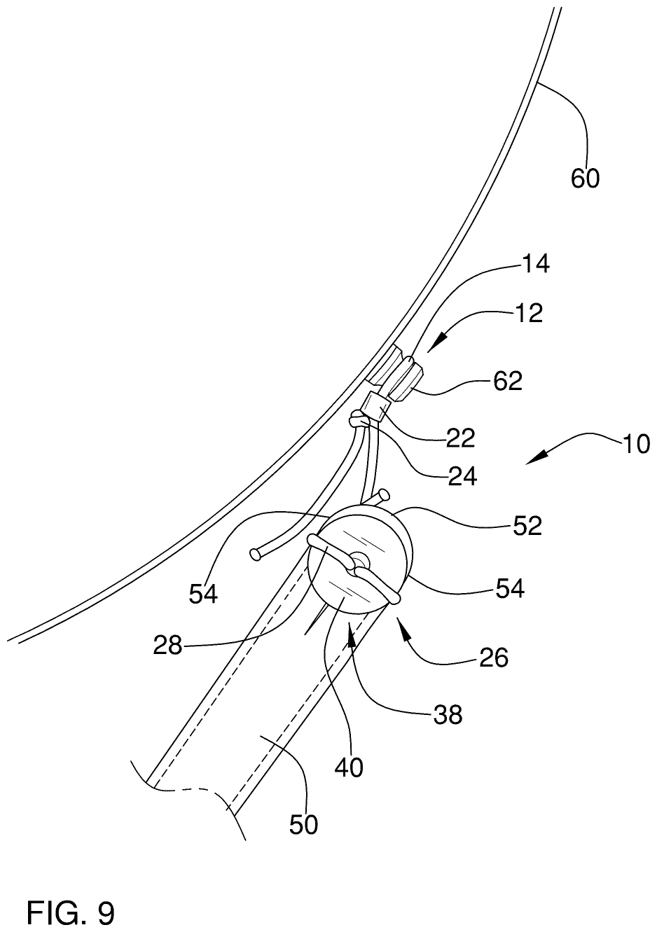

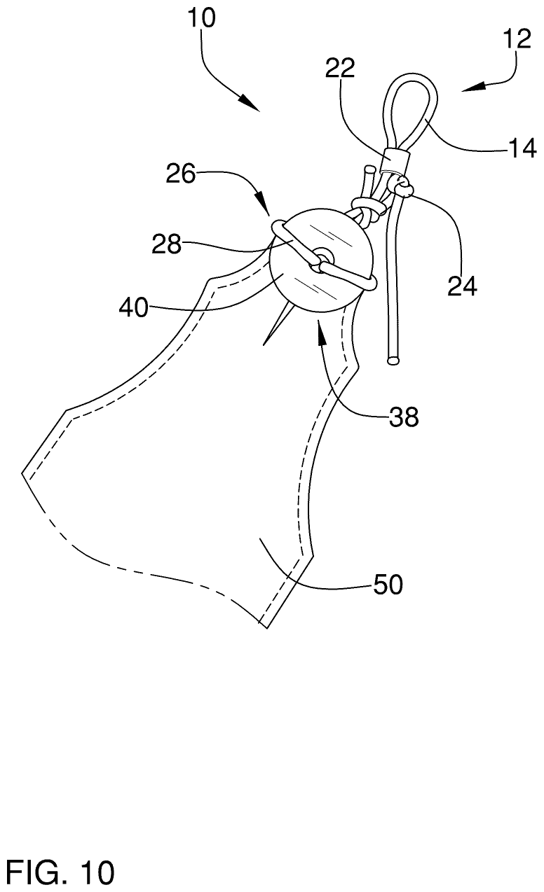

With reference now to the drawings, and in particular to FIGS. 1 through 10 thereof, a new connector apparatus embodying the principles and concepts of an embodiment of the disclosure and generally designated by the reference numeral 10 will be described.

As best illustrated in FIGS. 1 through 10, the connector assembly 10 generally comprises a knob mount 12 which comprises a cinching cord 14 that forms a loop 16 between a first end 32 segment 18 and a second end segment 20 of the cinching cord 14 and a sleeve 22 which is mounted around the first and second end segments 18, 20 of the cinching cord 14. The sleeve 22 is slidable along the cinching cord 14 to adjust a size of the loop 16 of the cinching cord 14. The knob mount 12 also includes a stop member 24 that is coupled to the first end 32 segment 18 of the cinching cord 14 and is positioned opposite the loop 16 of the cinching cord 14 across the sleeve 22. The stop member 24 prevents a movement of the sleeve 22 past the stop member 24. The stop member 24 is a stopper knot in the cinching cord 14 but may in other embodiments be a separate element mounted to the cinching cord 14.

A strap mount 26 is coupled to the first end 32 segment 18 of the cinching cord 14 of the knob mount 12. The strap mount 26 comprises a hitching cord 28 which forms a closed loop 29 and is sized and configured to mount to a shoulder strap 50 by being inserted through a receiving hole 58 of the shoulder strap 50 proximate to a free end 52 of the shoulder strap 50 and receiving the knob mount 12 through the closed loop 29. The cinching cord 14 of the knob mount 12 and the hitching cord 28 of the strap mount 26 are integrally formed from a single cord 30. However, in other embodiments, the cinching cord 14 and the hitching cord 28 may be separate elements.

The single cord 30 has a first end 32 and a second end 34, wherein the hitching cord 28 lies adjacent to the first end 32 and the cinching cord 14 lies adjacent to the second end 34. The single cord 30 forms a loop knot 36 adjacent to the first end 32 of the single cord 30 to form the closed loop 29 of the hitching cord 28. The stopper knot in the cinching cord 14 lies adjacent to the second end 34 of the single cord 30. The single cord 30 may, for example, comprise a tactical cord material.

A strap support 38 is also provided and is couplable to the strap mount 26 to prevent the strap mount 26 from constricting the shoulder strap 50 when attached thereto. The strap support 38 comprises a rigid disc 40 which has a first face 42, a second face 44, and a perimeter face 46 that extends between the first face 42 and the second face 44. The rigid disc 40 has a hole 48 which extends through the first face 42 and the second face 44.

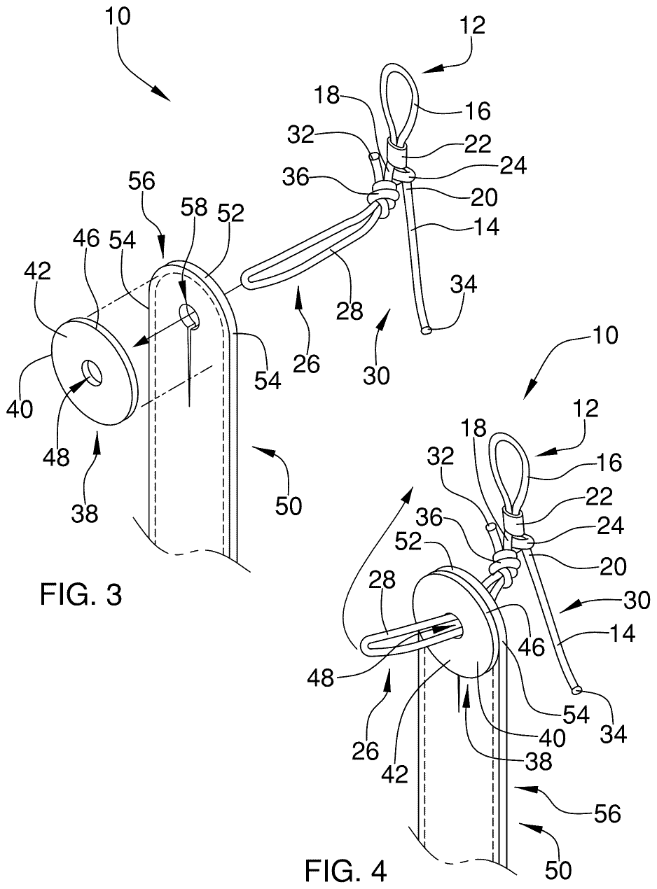

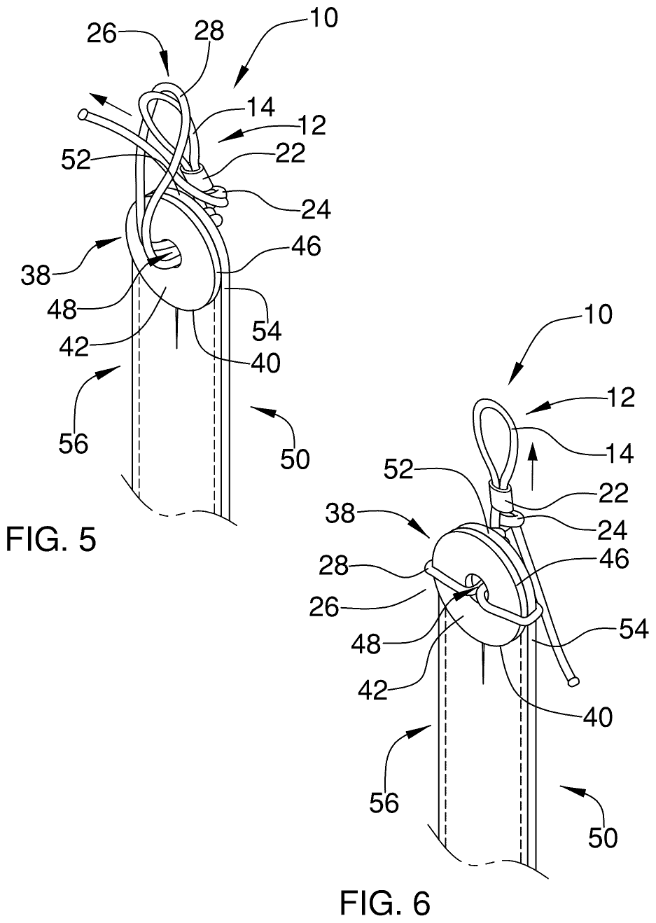

The strap support 38 couples to the shoulder strap 50 and the strap mount 26 simultaneously by inserting the closed loop 29 of the hitching cord 28 through the receiving hole 58 of the shoulder strap 50 and the hole 48 of the rigid disc 40 (FIG. 3), then drawing the closed loop 29 of the hitching cord 28 over the free end 52 of the shoulder strap 50 and the knob mount 12 (FIGS. 4 and 5). The knob mount 12 may then be drawn away from the receiving hole 58 of the shoulder strap 50 to tighten the hitching cord 28 against the rigid disc 40 and the shoulder strap 50. The result is shown in FIG. 6, in which two portions of the closed loop 29 of the hitching strap extend over respective ones of a pair of opposing portions of the perimeter face 46 of the rigid disc 40 and respective ones of a pair of opposing edges 54 of the shoulder strap 50.

The rigid disc 40 has a width between the opposing portions of the perimeter face 46 such that the rigid disc 40 is positionable to extend across the shoulder strap 50 between the pair of opposing edges 54 adjacent to the free end 52 of the shoulder strap 50 as seen in FIG. 6. The rigid disc 40 also has a shape that is complementary in shape to an end section 56 of the shoulder strap 50, also seen in FIG. 6. As such, the rigid disc 40 helps to brace the shoulder strap 50 such that it does not collapse under a constricting action of the hitching cord 28 on the shoulder strap 50. The rigid disc 40 has a circular shape but may have other shapes which are complementary in shape to end sections of other shoulder straps. It is also contemplated that the shape of the rigid disc 40 is not complementary in shape to the end section 56 of the shoulder strap 50. The rigid disc 40 may be a washer comprising a plastic material such as nylon.

In use, the hitching cord 28 is mounted to the shoulder strap 50 and the strap support 38 as described above. Then the knob mount 12 may secure to an attachment knob 62 of a stringed instrument 60 such as a guitar, a banjo, a lute, or the like by receiving the attachment knob 62 into the loop 16 of the cinching cord 14 and pulling the first end 32 segment 18 of the cinching cord 14 to cinch the cinching cord 14 around the attachment knob 62. Pulling on the first end 32 segment 18 draws the cinching cord 14 through the sleeve 22 to cause the stop member 24 to engage the sleeve 22 to constrict the size of the loop 16. The stringed instrument 60 may hang from the shoulder strap 50, which causes the hitching loop 16 to tighten on the shoulder strap 50 and the strap support 38 and causes the attachment knob 62 to cinch against the attachment knob 62 of the stringed instrument 60. This action thereby causes the connector assembly 10 to enhance a grip of the connector assembly 10 with the shoulder strap 50 and the attachment knob 62. The hitching loop 16 also may attach to the shoulder strap 50 without the strap support 38.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A connector assembly for attaching a shoulder strap to an attachment knob of a stringed instrument, the connector assembly comprising:
a knob mount comprising:
a cinching cord, the cinching cord forming a loop between a first end segment and a second end segment of the cinching cord; and
a sleeve slidably mounted around the first and second end segments of the cinching cord, the sleeve being slidable along the cinching cord to adjust a size of the loop of the cinching cord; and
a strap mount coupled to the first end segment of the cinching cord of the knob mount, the strap mount comprising a hitching cord which forms a closed loop, the closed loop of the hitching cord being sized and configured to mount to the shoulder strap by being inserted through a receiving hole of the shoulder strap proximate to a free end of the shoulder strap and receiving the knob mount through the closed loop.

2. The connector assembly of claim 1, wherein the knob mount further comprises a stop member coupled to the first end segment of the cinching cord, the stop member being positioned opposite the loop of the cinching cord across the sleeve, the stop member preventing a movement of the sleeve past the stop member.

3. The connector assembly of claim 2, wherein the stop member is a stopper knot in the cinching cord.

4. The connector assembly of claim 1, wherein the cinching cord of the knob mount and the hitching cord of the strap mount are integrally formed from a single cord.

5. The connector assembly of claim 1, further comprising a strap support which is couplable to the strap mount, the strap support comprising a rigid disc, the rigid disc having a first face, a second face, and a perimeter face extending between the first face and the second face, the rigid disc having a hole extending through the first face and the second face, the strap support being configured to be positionable over the shoulder strap at the receiving hole such that the closed loop of the hitching cord extends through the receiving hole of the shoulder strap and the hole of the rigid disc when mounting to the shoulder strap.

6. The connector assembly of claim 5, wherein the rigid disc has a width between opposing portions of the perimeter face such that the rigid disc is positionable to extend across the shoulder strap between a pair of opposing edges of the shoulder strap adjacent to the free end.

7. The connector assembly of claim 5, wherein the rigid disc has a shape which is configured to be complementary in shape to an end section of the shoulder strap.

8. A connector assembly for attaching a shoulder strap to an attachment knob of a stringed instrument, the connector assembly comprising:
a knob mount comprising:
a cinching cord, the cinching cord forming a loop between a first end segment and a second end segment of the cinching cord;
a sleeve slidably mounted around the first and second end segments of the cinching cord, the sleeve being slidable along the cinching cord to adjust a size of the loop of the cinching cord; and
a stop member coupled to the first end segment of the cinching cord, the stop member being positioned opposite the loop of the cinching cord across the sleeve, the stop member preventing a movement of the sleeve past the stop member, the stop member being a stopper knot in the cinching cord;
a strap mount coupled to the first end segment of the cinching cord of the knob mount, the strap mount comprising a hitching cord which forms a closed loop, the closed loop of the hitching cord being sized and configured to mount to the shoulder strap by being inserted through a receiving hole of the shoulder strap proximate to a free end of the shoulder strap and receiving the knob mount through the closed loop;
wherein the cinching cord of the knob mount and the hitching cord of the strap mount are integrally formed from a single cord; and
a strap support which is couplable to the strap mount, the strap support comprising a rigid disc, the rigid disc having a first face, a second face, and a perimeter face extending between the first face and the second face, the rigid disc having a hole extending through the first face and the second face, the strap support being configured to be positionable over the shoulder strap at the receiving hole such that the closed loop of the hitching cord extends through the receiving hole of the shoulder strap and the hole of the rigid disc when mounting to the shoulder strap, the rigid disc having a width between opposing portions of the perimeter face such that the rigid disc is positionable to extend across the shoulder strap between a pair of opposing edges of the shoulder strap adjacent to the free end, the rigid disc having a shape which is configured to be complementary in shape to an end section of the shoulder strap.
